(19) United States
(12) Patent Application Publication
(10) Pub. No.: US 2024/0319329 A1
(43) Pub. Date: Sep. 26, 2024

(54) SCANNING SYSTEM, SCANNING GUIDE GENERATING DEVICE, SCANNING METHOD, AND PROGRAM

(71) Applicant: NIPPON TELEGRAPH AND TELEPHONE CORPORATION, Tokyo (JP)

(72) Inventors: Yusuke YOSHIMURA, Tokyo (JP); Akira ITO, Tokyo (JP); Kenji HIYOSHI, Tokyo (JP); Koji ITASAKA, Tokyo (JP)

(73) Assignee: NIPPON TELEGRAPH AND TELEPHONE CORPORATION, Tokyo (JP)

(21) Appl. No.: 18/580,116

(22) PCT Filed: Jul. 20, 2021
(86) PCT No.: PCT/JP2021/027234

§ 371 Date: Jan. 17, 2024

(51) Int. Cl. G01S 7/22; G01S 13/88

(52) U.S. Cl. CPC G01S 7/22; G01S 13/885

(57) ABSTRACT

A scanning system (100) according to the present disclosure includes a scanning device (2) that moves on a ground surface and scans ground below the ground surface, and a scanning guide generation device (4), in which the scanning guide generation device (4) includes: an input unit (41) that receives an input of pipeline information indicating assumed position and shape of a pipeline in the ground and setting information indicating a condition of a traverse line indicating path and direction in which the scanning device (2) moves on the ground surface; a traverse line determination unit (42) that determines a traverse line (GD) on the basis of the pipeline information and the setting information; and a device control unit (47) that controls a display device (3) that displays a guide line (OB1) that is an image indicating the traverse line (GD), a projection device (5) that projects the guide line (OB1), or a drive device (6) that drives the scanning device (2).

### TECHNICAL FIELD

The present disclosure relates to a scanning system, a scanning guide generation device, a scanning method, and a program.

### BACKGROUND ART

As disclosed in Non Patent Literature 1, there is known a conventional technology of locating a buried object buried in the ground using an underground radar called a ground penetrating radar (GPR). In this technology, the GPR generates an electromagnetic wave toward the ground while moving, and performs scanning to receive a reflected electromagnetic wave reflected from a buried object having a dielectric constant different from that of a medium in the ground, thereby locating the buried object.

As disclosed in Non Patent Literature 2, there is known a technology of marking a traverse line on which a GPR moves while scanning the ground when performing scanning using the GPR. In this technology, an operator determines a traverse line by referring to, for example, a drawing illustrating an assumed position of a buried object or using an electromagnetic wave guidance method, and marks the traverse line on a ground surface using a choke, a leveling string, or the like. As a result, the operator can recognize the traverse line and move the GPR on the basis of the traverse line.

### CITATION LIST

### Non Patent Literature

Non Patent Literature 1: “Chichu radar gijutsu ni kansuru chousakentoukai houkokusho (Report from Ground Penetrating Radar Technology Survey Study Group)”, Ground Penetrating Radar Technology Survey Study Group, March 2017 [online], [Retrieved on Jul. 5, 2021], the Internet <URL: https://www.soumu.go.jp/main #content/000477180.pdf> Non Patent Literature 2: “Espar tansa sagyou manual <Maisetsubutu chousa> <Kudou chousa> (Espar Exploration Work Manual <Investigation of Buried Object> <Investigation of Cavity>)”, Espar Exploration Association, April 2013 [online], [Retrieved on Jul. 5, 2021], the Internet <URL: http://www.kouhounavi.com/navi/data/toku/espar/gijutsu/espa r-manu.pdf>

### SUMMARY OF INVENTION

### Technical Problem

However, when a scanning device such as a GPR performs scanning, it may take a lot of time for an operator who operates the scanning device to mark a traverse line. As an example, the work of marking the traverse line may take more time than the time required for the scanning itself. Therefore, it takes time to scan a buried object such as a pipeline.

An object of the present disclosure made in view of such circumstances is to provide a scanning system, a scanning guide generation device, a scanning method, and a program capable of quickly scanning a pipeline.

### Solution to Problem

In order to solve the above problem, a scanning system according to the present disclosure includes a scanning device that moves on a ground surface and scans ground below the ground surface, and a scanning guide generation device, in which the scanning guide generation device includes: an input unit that receives an input of pipeline information indicating assumed position and shape of a pipeline in the ground and setting information indicating a condition of a traverse line indicating path and direction in which the scanning device moves on the ground surface; a traverse line determination unit that determines the traverse line on the basis of the pipeline information and the setting information; and a device control unit that controls a display device that displays a guide line that is an image indicating the traverse line, a projection device that projects the guide line, or a drive device that drives the scanning device.

In order to solve the above problem, a scanning guide generation device according to the present disclosure includes: an input unit that receives an input of pipeline information indicating position and shape of a pipeline in ground below a ground surface on which a scanning device moves and setting information indicating a condition of a traverse line indicating path and direction in which the scanning device moves; a traverse line determination unit that determines the traverse line on the basis of the pipeline information and the setting information; and a device control unit that controls a display device that displays a guide line that is an image indicating the traverse line, a projection device that projects the guide line, or a drive device that drives the scanning device.

Furthermore, in order to solve the above problem, a scanning method according to the present disclosure includes steps: of receiving an input of pipeline information indicating assumed position and shape of a pipeline in ground below a ground surface on which a scanning device moves and setting information indicating a condition of a traverse line indicating path and direction in which the scanning device moves on the ground surface; determining the traverse line on the basis of the pipeline information and the setting information; and controlling a display device that displays a guide line that is an image indicating the traverse line, a projection device that projects the guide line, or a drive device that drives the scanning device.

Furthermore, in order to solve the above object, a program according to the present disclosure causes a computer to function as the above-described scanning guide generation device.

### Advantageous Effects of Invention

According to a scanning system, a scanning guide generation device, a scanning method, and a program according to the present disclosure, it is possible to quickly scan a pipeline.

### BRIEF DESCRIPTION OF DRAWINGS

FIG. 1 is a schematic diagram of a scanning guide generation system according to a first embodiment.

FIG. 2 is a diagram illustrating an appearance of a scanning device, a display device, and a scanning guide generation device illustrated in FIG. 1.

FIG. 3 is a diagram for explaining an example of a traverse line determined by a traverse line determination unit illustrated in FIG. 1.

FIG. 4 is a diagram for explaining another example of a traverse line determined by the traverse line determination unit illustrated in FIG. 1.

FIG. 5 is a diagram illustrating an example of a superimposed image displayed by the display device 3 illustrated in FIG. 1.

FIG. 6 is a flowchart illustrating an example of an operation of a scanning guide generation device according to a first embodiment.

FIG. 7A is a part of a flowchart illustrating an example of processing of determining a traverse line illustrated in FIG. 6.

FIG. 7B is a part of a flowchart illustrating an example of processing of determining a traverse line illustrated in FIG. 6.

FIG. 7C is a part of a flowchart illustrating an example of processing of determining a traverse line illustrated in FIG. 6.

FIG. 8 is a schematic diagram of a scanning guide generation system according to a second embodiment.

FIG. 9A is a diagram illustrating an example of a projection image projected by the projection device illustrated in FIG. 8.

FIG. 9B is a diagram illustrating another example of the projection image projected by the projection device illustrated in FIG. 8.

FIG. 10 is a flowchart illustrating an example of the operation of the scanning guide generation device according to the second embodiment.

FIG. 11 is a schematic diagram of a scanning guide generation system according to a third embodiment.

FIG. 12 is a diagram for explaining an example of a traverse line and an auxiliary line determined by the traverse line determination unit illustrated in FIG. 11.

FIG. 13 is a flowchart illustrating an example of the operation of the scanning guide generation device according to the third embodiment.

FIG. 14 is a hardware block diagram of the scanning guide generation device.

### DESCRIPTION OF EMBODIMENTS

### First Embodiment

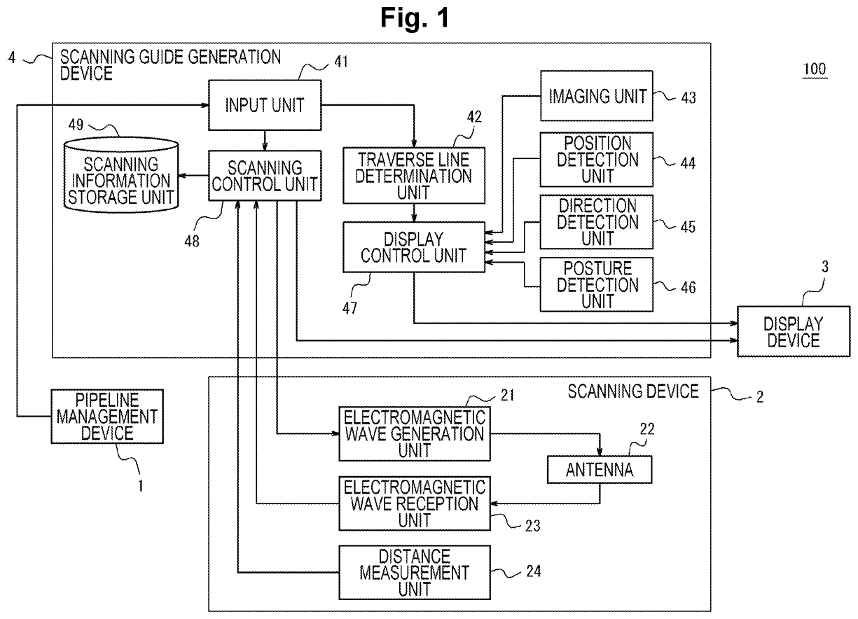

An overall configuration of a first embodiment will be described with reference to FIG. 1. FIG. 1 is a schematic diagram of a scanning system 100 according to a first embodiment.

As illustrated in FIG. 1, the scanning system 100 according to the first embodiment includes a pipeline management device 1, a scanning device 2, a display device 3, and a scanning guide generation device 4.

### <Configuration of Pipeline Management Device>

The pipeline management device 1 includes a computer that includes a control unit (controller), a memory, and a communication interface. The control unit may include dedicated hardware such as an application specific integrated circuit (ASIC) or a field-programmable gate array (FPGA), may include a processor, or may include both dedicated hardware and a processor. For the communication interface, for example, a standard such as Ethernet (registered trademark), fiber distributed data interface (FDDI), or Wi-Fi (registered trademark) may be used. The memory may be a hard disk drive (HDD), a solid-state drive (SSD), an electrically erasable programmable read-only memory (EEPROM), a read-only memory (ROM), and a random access memory (RAM).

The pipeline management device 1 stores pipeline information of a pipeline buried in the ground. The pipeline information indicates assumed shape and position of the pipeline. The pipeline management device 1 transmits pipeline information to a scanning guide generation device 4. The pipeline management device 1 may transmit the pipeline information to the scanning guide generation device 4 on the basis of a request from the scanning guide generation device 4.

### <Configuration of Scanning Device>

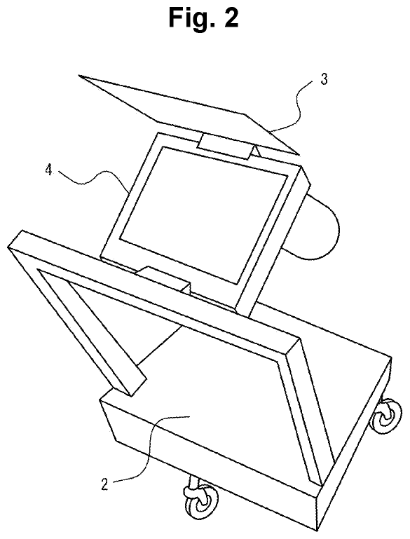

The scanning device 2 scans the ground by generating an electromagnetic wave and receiving a reflected electromagnetic wave that is a reflected wave of the electromagnetic wave. The scanning device 2 moves on the ground surface and scans the ground below the ground surface. The scanning device 2 can be a ground penetrating radar (GPR) as illustrated in an external appearance in FIG. 2. The electromagnetic wave used in the scanning device 2 can be an electromagnetic wave in a frequency range of 1 to 1000 MHz.

As illustrated in FIG. 1, the scanning device 2 includes an electromagnetic wave generation unit 21, an antenna 22, an electromagnetic wave reception unit 23, and a distance measurement unit 24.

The electromagnetic wave generation unit 21 supplies a current for generating an electromagnetic wave to the antenna 22 under the control of the scanning guide generation device 4.

The antenna 22 generates an electromagnetic wave by changing a magnetic field by the current supplied by the electromagnetic wave generation unit 21. The antenna 22 receives the reflected electromagnetic wave of the electromagnetic wave. When the current flowing through the antenna 22 is changed by the received reflected electromagnetic wave, the antenna 22 converts the reflected electromagnetic wave into a current.

The electromagnetic wave reception unit 23 receives the current converted by the antenna 22.

The distance measurement unit 24 measures a distance from a predetermined point. The predetermined point can be, for example, a unit scanning start position. The unit scanning start position is a position at which unit scanning is started, and the unit scanning is scanning performed by the scanning device 2 while moving on one straight line in a direction orthogonal to the extending direction of the pipeline.

### <Configuration of Display Device>

The display device 3 displays an image under the control of the scanning guide generation device 4. The display device 3 includes an organic electro-luminescence (EL), a liquid crystal panel, and the like. As illustrated in FIG. 2, the display device 3 may be configured integrally with the scanning guide generation device 4. The display device 3 may be configured separately from the scanning guide generation device 4, and can be, for example, an augmented reality (AR) device such as a head mount type, a glasses type, or a tablet type.

The display device 3 displays a superimposed image generated by the scanning guide generation device 4 and described in detail later. The display device 3 may display information indicating a distance and the intensity (electromagnetic wave intensity) of the reflected electromagnetic wave at the distance. The distance is a distance from a predetermined point measured by the distance measurement unit 24.

### <Configuration of Scanning Guide Generation Device>

As illustrated in FIG. 1, the scanning guide generation device 4 includes an input unit 41, a traverse line determination unit 42, an imaging unit 43, a position detection unit 44, a direction detection unit 45, a posture detection unit 46, a display control unit (device control unit) 47, a scanning control unit 48, and a scanning information storage unit 49.

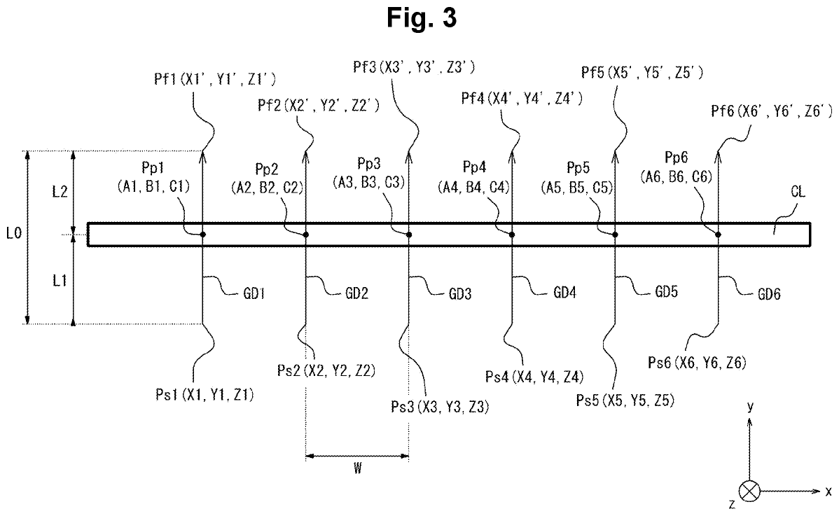

Here, an outline of a traverse line, which is a path in which the scanning device 2 moves, determined by the scanning guide generation device 4 of the present embodiment will be described. The traverse line is a vector indicating a path in which the scanning device 2 moves and a direction in which the scanning device 2 moves in the path. As illustrated in FIG. 3, in the present embodiment, the scanning device 2 performs unit scanning for performing scanning while moving on one straight line in a direction (y-axis direction) orthogonal to the extending direction (x-axis direction) of the pipeline. FIG. 3 illustrates a traverse line GD (in this example, GD1 to GD6) of each unit scanning. The scanning device 2 performs entire scanning by repeating unit scanning at a predetermined scanning interval W from one end to the other end in the extending direction (x-axis direction) of the pipeline.

Returning to FIG. 1, the input unit 41 includes an input interface. The input interface may be a pointing device, a keyboard, a mouse, or the like. The input interface may be a communication interface that receives information from an external device. The traverse line determination unit 42, the display control unit 47, and the scanning control unit 48 constitute the control unit. The imaging unit 43 may include a camera including an imaging element, an optical element, and the like. The position detection unit 44 may be constituted by a position sensor, and the position sensor may be, for example, a GPS receiver. For example, the direction detection unit 45 may include an electronic compass. The posture detection unit 46 may include a gyro sensor that detects an angle or an angular velocity of an attached object. The scanning information storage unit 49 may include a memory.

The input unit 41 receives an input of pipeline information and setting information.

The pipeline information indicates assumed position and shape of a pipeline buried in the ground. The pipeline information may be a plan view showing position and shape by a polyline or the like, or may be a three-dimensional view showing position and shape three-dimensionally.

The setting information indicates a condition of a traverse line GD indicating path and direction in which the scanning device 2 moves on the ground surface as illustrated in FIG. 3. The setting information can include a scanning length, a scanning interval W, and an entire scanning start position.

The scanning length indicates a length by which the scanning device 2 moves on one straight line. The scanning length can include any of a first scanning length L1, a second scanning length L2, and an entire scanning length L0. The first scanning length L1 is a length from a unit scanning start position Ps to a pipeline scanning position Pp. The unit scanning start position Ps is a position where the unit scanning is started. The pipeline scanning position Pp is a position where a pipeline corresponding region CL and a straight line extending from the unit scanning start position Ps in the orthogonal direction (the y-axis direction in the example of FIG. 3) of the extending direction of the pipeline (the x-axis direction in the example of FIG. 3) intersect. The pipeline corresponding region CL is a region obtained by projecting a region of the pipeline in the ground onto the ground surface. In other words, the pipeline corresponding region CL is a region on the ground surface located immediately above the region of the pipeline in the ground. The second scanning length L2 is a length from the pipeline scanning position Pp to a unit scanning end position Pf. The scanning length is any numerical value that can be appropriately determined by the operator according to the characteristics of the pipeline to be scanned, the purpose of scanning, and the like. The unit of the scanning length may be cm (centimeter), m (meter), or the like.

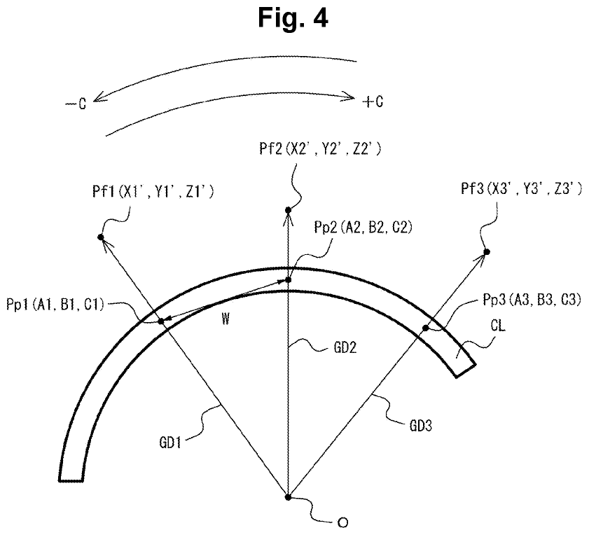

The scanning interval W indicates an interval in the extending direction of the pipeline in unit scanning. As described above, the unit scanning is performed while moving on one straight line extending in the direction orthogonal to the extending direction of the pipeline corresponding region CL. In the example in which the pipeline is linear, as illustrated in FIG. 3, the extending direction of the pipeline corresponding region CL is the longitudinal direction (x-axis direction) of the pipeline corresponding region CL, and the orthogonal direction is the lateral direction (y-axis direction) of the pipeline corresponding region CL. In an example in which the pipeline has an arc shape, as illustrated in FIG. 4, the extending direction of the pipeline corresponding region CL is the circumferential direction (±C direction) of the pipeline corresponding region CL, and the orthogonal direction is the radial direction of the pipeline corresponding region CL. The scanning interval W is any numerical value that can be appropriately determined by the operator according to the characteristics of the pipeline to be scanned, the purpose of scanning, and the like. The unit of the scanning interval W may be cm (centimeter), m (meter), or the like.

The entire scanning start position is a position at which the entire scanning including the plurality of pieces of unit scanning is started. The entire scanning start position may be a position of the scanning device 2 at the start time of the entire scanning specified by the operator using the map data. Furthermore, the entire scanning start position may be a position of the scanning device 2 at a start time of entire scanning acquired from a position detection center such as a global navigation satellite system (GNSS). The entire scanning start position may be indicated by coordinates in an orthogonal coordinate system. The entire scanning start position may be indicated by latitude, longitude, and altitude. The same applies to the unit scanning start position Ps, the pipeline scanning position Pp, and the unit scanning end position Pf.

The input unit 41 may receive an input of the pipeline information and the setting information by the operation of the operator. For example, the input unit 41 may receive an input of the pipeline information by receiving the pipeline information from the pipeline management device 1.

The traverse line determination unit 42 determines a traverse line GD indicating path and direction in which the scanning device 2 moves, on the basis of the pipeline information and the setting information input by the input unit 41.

Specifically, the traverse line determination unit 42 determines a unit scanning start position Ps (in the example of FIG. 3, Pp1 to Pp6) at which the unit scanning is started on the basis of the entire scanning start position. The traverse line determination unit 42 determines the unit scanning end position Pf (in the example of FIG. 3, Pf1 to Pf6), which is a position to end the unit scanning, on the basis of the unit scanning start position Ps, the extending direction of the pipeline indicated by the shape (the x-axis direction in the example of FIG. 3), and the scanning length. The traverse line determination unit 42 determines the traverse line GD in the unit scanning on the basis of the unit scanning start position Ps and the unit scanning end position Pf. The traverse line determination unit 42 determines the traverse line GD in the unit scanning a plurality of times on the basis of the scanning interval W to determine the traverse line GD of the entire scanning including the plurality of pieces of unit scanning.

As a first example, processing of the traverse line determination unit 42 in a case where the pipeline extends linearly as illustrated in FIG. 3 will be described in detail. In this example, the scanning length included in the setting information is the second scanning length L2.

First, the traverse line determination unit 42 determines the entire scanning start position as a first unit scanning start position Ps1. Then, the traverse line determination unit 42 determines whether there is an intersection between a straight line extending from the first unit scanning start position Ps1 in a direction (y-axis direction) orthogonal to the extending direction (x-axis direction) of the pipeline and the pipeline corresponding region CL. When determining that there is an intersection, the traverse line determination unit 42 determines the intersection as the first pipeline scanning position Pp1. Then, the traverse line determination unit 42 determines a position where the length in the y-axis direction from the first pipeline scanning position Pp1 is the second scanning length L2 as the first unit scanning end position Pf1. Then, the traverse line determination unit 42 determines a vector indicating length and direction from the first unit scanning start position Ps1 to the first unit scanning end position Pf1 as the traverse line GD1 in the first unit scanning.

Next, the traverse line determination unit 42 determines a position separated from the first unit scanning start position Ps1 by the scanning interval W in one direction (+x-axis direction in the example of FIG. 3) of the extending direction of the pipeline as the second unit scanning start position Pp2. Then, the traverse line determination unit 42 determines whether there is an intersection between a straight line extending from the second unit scanning start position Ps2 in the y-axis direction and the pipeline corresponding region CL. When determining that there is an intersection, the traverse line determination unit 42 determines the intersection as the second pipeline scanning position Pp2. Then, the traverse line determination unit 42 determines a position where the length in the y-axis direction from the second pipeline scanning position Pp2 is the second scanning length L2 as the second unit scanning end position Pf2. Then, the traverse line determination unit 42 determines a vector indicating length and direction from the second unit scanning start position Ps2 to the second unit scanning end position Pf2 as the traverse line GD2 in the second unit scanning.

As described above, the traverse line determination unit 42 determines, as an i-th unit scanning start position Psi, a position separated by the scanning interval W in the +x-axis direction from an (i−1)th unit scanning start position Ps (i−1) (i is an integer of 2 or more). Then, the traverse line determination unit 42 determines whether there is an intersection between a straight line extending from the i-th unit scanning start position Psi in the y-axis direction and the pipeline corresponding region CL. When determining that there is an intersection, the traverse line determination unit 42 determines the intersection as the i-th pipeline scanning position Ppi. Then, the traverse line determination unit 42 determines a position where the length in the y-axis direction from the i-th pipeline scanning position Ppi is the second scanning length L2 as the i-th unit scanning end position Pfi. Then, the traverse line determination unit 42 determines a vector indicating length and direction from the i-th unit scanning start position Psi to the i-th unit scanning end position Pfi as the traverse line GDi in the i-th unit scanning.

When determining that there is no intersection between the straight line extending in the y-axis direction from the i-th unit scanning start position Psi and the pipeline corresponding region CL, the traverse line determination unit 42 ends the determination of the traverse line GDi located in the +x-axis direction from the traverse line GD1.

Furthermore, the traverse line determination unit 42 similarly determines the traverse line GDj located in the other direction (the −x-axis direction in the example of FIG. 3) of the extending direction of the pipeline corresponding region CL from the first unit scanning start position Ps1. At this time, when determining that there is no intersection between the straight line extending in the y-axis direction from the j-th unit scanning start position Psj and the pipeline corresponding region CL, the traverse line determination unit 42 ends the determination of the traverse line GDj located in the −x-axis direction from the traverse line GD1. As a result, the traverse line determination unit 42 can determine the traverse line GD for guiding the entire scanning including the traverse lines GD1, GDi, and GDj.

As illustrated in FIG. 3, the traverse line GD1 may be represented as a vector having coordinates (X1, Y1, Z1) in the real space as a start point and coordinates (X1′, Y1′, Z1′) as an end point. The same applies to the traverse lines GDi and GDj.

As a second example, processing of the traverse line determination unit 42 in a case where the pipeline extends in an arc shape as illustrated in FIG. 4 will be described in detail. In this example, the scanning length included in the setting information is the second scanning length L2. Furthermore, in this example, the entire scanning start position included in the setting information is a center O of a circle having an arc formed by the pipeline as a part.

First, the traverse line determination unit 42 determines the center O that is the entire scanning start position as a first unit scanning start position Ps1. Then, the traverse line determination unit 42 determines an intersection of a line extending from the first unit scanning start position Ps1 in a direction (radial direction of the pipeline) orthogonal to the extending direction (+C direction) of the pipeline and the pipeline corresponding region CL as the first pipeline scanning position Pp1. Then, the traverse line determination unit 42 determines a position where the length in the radially outer direction from the first pipeline scanning position Pp1 is the second scanning length L2 as the first unit scanning end position Pf1. Then, the traverse line determination unit 42 determines a vector indicating length and direction from the first unit scanning start position Ps1 to the first unit scanning end position Pf1 as the traverse line GD1 in the first unit scanning.

Next, the traverse line determination unit 42 determines the center O that is the entire scanning start position as the second unit scanning start position Ps2. Then, the traverse line determination unit 42 determines whether a position separated from the first pipeline scanning position Pp1 in the +C direction and having a length between the position and the first pipeline scanning position Pp1 being the scanning interval W exists in the pipeline corresponding region CL. When it is determined that the position exists in the pipeline corresponding region CL, the traverse line determination unit 42 determines the position as the second pipeline scanning position Pp2. Then, the traverse line determination unit 42 determines a vector indicating length and direction from the second unit scanning start position Ps2 to the second unit scanning end position Pf2 as the traverse line GD2 in the second unit scanning.

As described above, the traverse line determination unit 42 determines the center O that is the entire scanning start position as the i-th unit scanning start position Psi. The traverse line determination unit 42 determines whether a position separated from the (i−1)th pipeline scanning position Pp(i−1) in the +C direction and having a length between the position and the (i−1)th pipeline scanning position Pp(i−1) being the scanning interval W exists in the pipeline corresponding region CL. When it is determined that the position exists in the pipeline corresponding region CL, the traverse line determination unit 42 determines the position as the i-th pipeline scanning position Ppi. Then, the traverse line determination unit 42 determines the i-th unit scanning end position Pfi where the length in the radially outer direction from the i-th pipeline scanning position Ppi is the second scanning length L2. Then, the traverse line determination unit 42 determines a vector indicating length and direction from the i-th unit scanning start position Psi to the i-th unit scanning end position Pfi as the traverse line GDi in the i-th unit scanning.

When the traverse line determination unit 42 determines that a position separated from the (i−1)th pipeline scanning position Pp(i−1) in the +C direction and having a length between the position and the (i−1)th pipeline scanning position Pp(i−1) being the scanning interval W does not exist in the pipeline corresponding region CL, the traverse line determination unit 42 ends the determination of the traverse line GDi located in the +C direction from the traverse line GD1.

Furthermore, the traverse line determination unit 42 similarly determines the traverse line GDj (j is an integer of two or more) located in the other direction (the −C direction in the example of FIG. 4) of the extending direction of the pipeline from the first unit scanning start position Ps1. Then, when determining that there is no intersection between the straight line extending in the radial direction from the j-th unit scanning start position Psj and the pipeline corresponding region CL, the traverse line determination unit 42 ends the determination of the traverse line GDj located in the C direction from the traverse line GD1.

The imaging unit 43 generates a captured image obtained by imaging the ground surface. Specifically, the imaging unit 43 generates a captured image obtained by imaging a ground surface located above ground in which a pipeline to be scanned by the scanning device 2 is assumed to be buried.

The position detection unit 44 detects the position of the position detection unit 44. As a result, the position detection unit 44 detects the position of the imaging surface of the imaging unit 43 included in the scanning guide generation device 4 together with the position detection unit 44.

The direction detection unit 45 detects the direction of the direction detection unit 45. As a result, the direction detection unit 45 detects the direction of the imaging surface of the imaging unit 43 included in the scanning guide generation device 4 together with the direction detection unit 45.

The posture detection unit 46 detects the posture of the posture detection unit 46. As a result, the posture detection unit 46 detects the posture of the imaging surface of the imaging unit 43 included in the scanning guide generation device 4 together with the posture detection unit 46.

The display control unit 47 controls the display device 3 that displays a guide line OB1, which is an image indicating the traverse line GD.

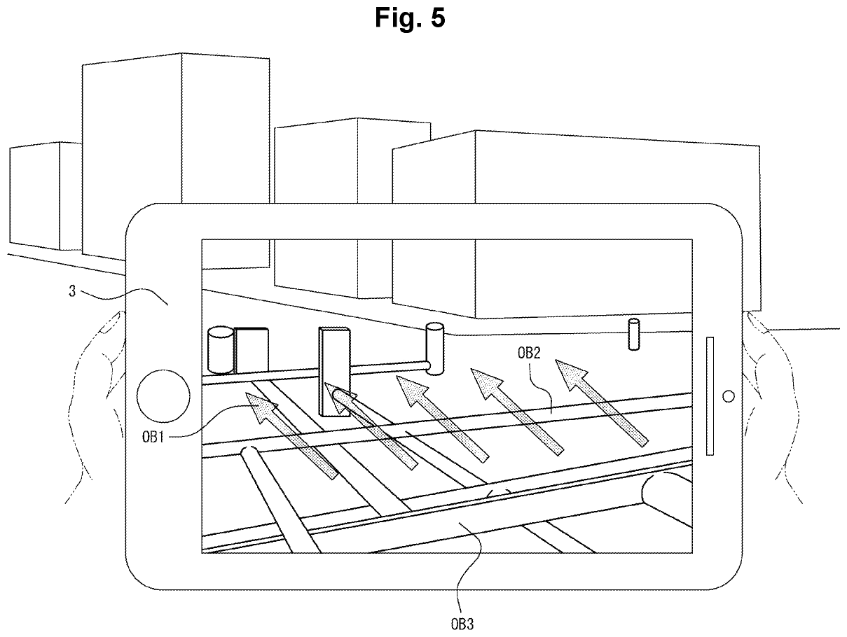

Specifically, the display control unit 47 generates a superimposed image in which the guide line OB1 is superimposed on the captured image on the basis of the position, direction, and posture of the imaging surface of the imaging unit 43. For example, the display control unit 47 calculates the correspondence relationship between the position in the real space and the position in the captured image on the basis of the position, direction, and posture of the imaging surface of the imaging unit 43. Then, as illustrated in FIG. 5, the display control unit 47 generates a superimposed image in which the guide line OB1 is superimposed on a position in the captured image corresponding to the position of the traverse line GD in the real space on the basis of the correspondence relationship.

At this time, the display control unit 47 may generate a superimposed image in which an image object OB2 indicating a pipeline to be scanned is further superimposed on the captured image. Specifically, the display control unit 47 may generate a superimposed image in which the image object OB2 is superimposed on a position in the captured image corresponding to an assumed position of the pipeline in the real space.

Furthermore, the display control unit 47 may generate a superimposed image in which an image object OB3 indicating a pipeline different from the pipeline to be scanned is further superimposed on the captured image. Specifically, the display control unit 47 may generate a superimposed image in which the image object OB3 is superimposed on a position in the captured image corresponding to the position of the pipeline indicated by the image object OB3 in the real space.

The display control unit 47 controls the display device 3 to display the superimposed image. In the example illustrated in FIG. 5, the display device 3 is a tablet configured separately from the scanning guide generation device 4. However, the present invention is not limited thereto, and also in a case where the display device 3 is integrated with the scanning guide generation device 4 as illustrated in FIG. 2, the display control unit 47 controls the display device 3 to display a superimposed image in the same manner.

The scanning control unit 48 controls the scanning device 2 on the basis of the operation command whose input is received by the input unit 41. For example, when the operation command includes a generation command for generating an electromagnetic wave, the scanning control unit 48 controls the scanning device 2 to generate an electromagnetic wave.

When the scanning device 2 receives the reflected electromagnetic wave of the electromagnetic wave and converts the reflected electromagnetic wave into a current, the scanning control unit 48 stores the distance measured by the distance meter and the electromagnetic wave intensity indicated by the current at the distance in the scanning information storage unit 49. The scanning control unit 48 may cause the display device 3 to display the distance and the electromagnetic wave intensity at the distance.

The scanning information storage unit 49 stores the distance and the electromagnetic wave intensity at the distance under the control of the scanning control unit 48.

### <Operation of Scanning System>

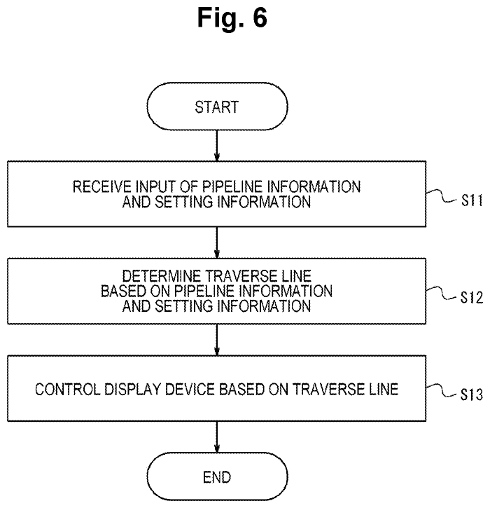

Here, operation of the scanning system 100 according to the first embodiment will be described with reference to FIG. 6. FIG. 6 is a flowchart illustrating an example of the operation of the scanning system 100 according to the first embodiment. The operation in the scanning system 100 described below with reference to FIG. 6 corresponds to an example of the scanning method of the scanning system 100 according to the first embodiment.

In step S11, the input unit 41 receives an input of pipeline information indicating position and shape of a pipeline in the ground below the ground surface on which the scanning device 2 moves, and setting information indicating a condition of a traverse line GD indicating path and direction for moving the scanning device 2 on the ground surface.

In step S12, the traverse line determination unit 42 determines the traverse line GD on the basis of the pipeline information and the setting information.

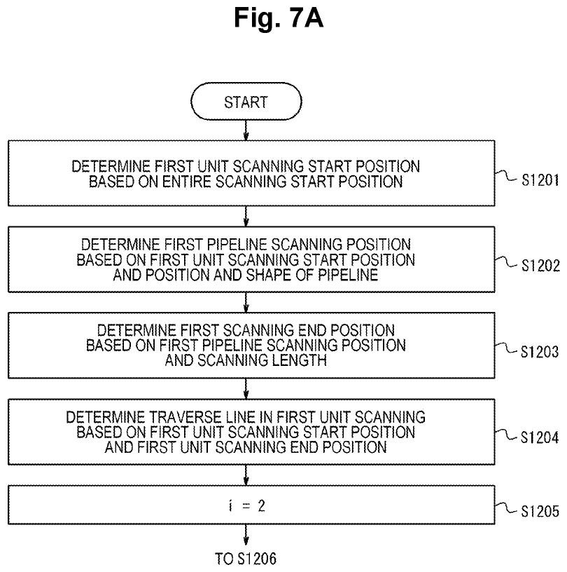

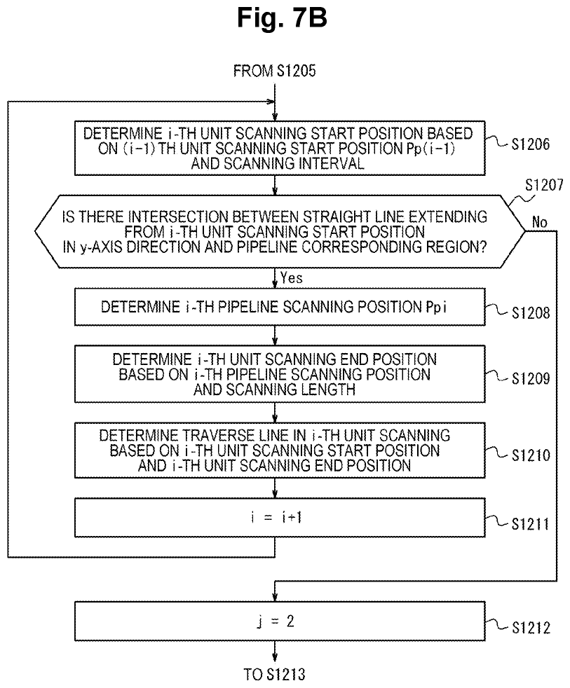

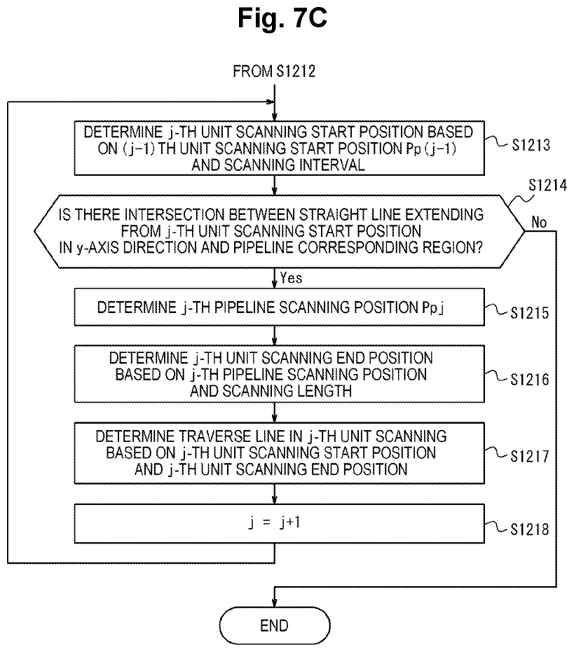

Here, details of the processing of determining the traverse line GD in step S12 will be described with reference to FIGS. 7A, 7B, and 7C. Here, details of processing in an example in which the pipeline is linear and the scanning length is the second scanning length L2 as illustrated in FIG. 3 will be described.

In step S1201, the traverse line determination unit 42 determines the first unit scanning start position Ps1 on the basis of the entire scanning start position. In the example illustrated in FIG. 3, the traverse line determination unit 42 determines the entire scanning start position as a first unit scanning start position Ps1.

In step S1202, the traverse line determination unit 42 determines the first pipeline scanning position Pp1 on the basis of the first unit scanning start position Ps1 and the position and shape of the pipeline. In the example illustrated in FIG. 3, the traverse line determination unit 42 determines an intersection of a straight line extending from the first unit scanning start position Ps1 in a direction (y-axis direction) orthogonal to the extending direction (x-axis direction) of the pipeline corresponding region CL and the pipeline corresponding region CL as the first pipeline scanning position Pp1.

In step S1203, the traverse line determination unit 42 determines the first unit scanning end position Pf1 on the basis of the first pipeline scanning position Pp1 and the scanning length. In the example illustrated in FIG. 3, the traverse line determination unit 42 determines a position where the length in the y-axis direction from the first pipeline scanning position Pp1 is the second scanning length L2 as the first unit scanning end position Pf1.

In step S1204, the traverse line determination unit 42 determines the traverse line GD1 in the first unit scanning on the basis of the first unit scanning start position Ps1 and the first unit scanning end position Pf1. In the example illustrated in FIG. 3, the traverse line determination unit 42 determines a vector indicating length and direction from the first unit scanning start position Ps1 to the first unit scanning end position Pf1 as the traverse line GD1 in the first unit scanning.

In step S1205, the traverse line determination unit 42 sets i=2.

In step S1206, the traverse line determination unit 42 determines the i-th unit scanning start position Psi on the basis of the (i−1)th unit scanning start position Ps (i−1) and the scanning interval W. In the example illustrated in FIG. 3, the traverse line determination unit 42 determines, as an i-th unit scanning start position Psi, a position separated by the scanning interval W in the +x-axis direction from an (i−1)th unit scanning start position Ps (i−1).

In step S1207, the traverse line determination unit 42 determines whether there is an intersection between a straight line extending from the i-th unit scanning start position Psi in the y-axis direction and the pipeline corresponding region CL.

When it is determined in step S1207 that there is an intersection, the traverse line determination unit 42 determines the i-th pipeline scanning position Ppi in step S1208. Specifically, the traverse line determination unit 42 determines the intersection as the i-th pipeline scanning position Ppi.

In step S1209, the traverse line determination unit 42 determines the i-th unit scanning end position Pfi on the basis of the i-th pipeline scanning position Ppi and the scanning length. In the example illustrated in FIG. 3, the traverse line determination unit 42 determines a position where the length in the y-axis direction from the i-th pipeline scanning position Ppi is the second scanning length L2 as the i-th unit scanning end position Pfi.

In step S1210, the traverse line determination unit 42 determines the traverse line GDi in the i-th unit scanning on the basis of the i-th unit scanning start position Psi and the i-th unit scanning end position Pfi. In the example illustrated in FIG. 3, the traverse line determination unit 42 determines a vector indicating length and direction from the i-th unit scanning start position Psi to the i-th unit scanning end position Pfi as the traverse line GDi in the i-th unit scanning.

In step S1211, i=i+1 is set, the process returns to step S1206, and the process is repeated.

When it is determined in step S1207 that there is no intersection, j=2 is set in step S1212.

In step S1213, the traverse line determination unit 42 determines the j-th unit scanning start position Psj on the basis of the (j−1)th unit scanning start position Ps (j−1) and the scanning interval W. In the example illustrated in FIG. 3, the traverse line determination unit 42 determines, as a j-th unit scanning start position Psj, a position separated by the scanning interval W in the −x-axis direction from an (j−1)th unit scanning start position Ps (j−1).

In step S1214, the traverse line determination unit 42 determines whether there is an intersection between a straight line extending from the j-th unit scanning start position Psj in the y-axis direction and the pipeline corresponding region CL.

When it is determined in step S1214 that there is an intersection, the traverse line determination unit 42 determines the j-th pipeline scanning position Ppj in step S1215. In the example illustrated in FIG. 3, the traverse line determination unit 42 determines the intersection as the j-th pipeline scanning position Ppj.

In step S1216, the traverse line determination unit 42 determines the j-th unit scanning end position Pfj on the basis of the j-th pipeline scanning position Ppj and the scanning length. In the example illustrated in FIG. 3, the traverse line determination unit 42 determines a position where the length in the y-axis direction from the j-th pipeline scanning position Ppj is the second scanning length L2 as the j-th unit scanning end position Pfj.

In step S1217, the traverse line determination unit 42 determines the traverse line GDj in the j-th unit scanning on the basis of the j-th unit scanning start position Psj and the j-th unit scanning end position Pfj. In the example illustrated in FIG. 3, the traverse line determination unit 42 determines length and direction from the j-th unit scanning start position Psj to the j-th unit scanning end position Pfj as the traverse line GDj in the j-th unit scanning.

In step S1218, j=j+1 is set, the process returns to step S1213, and the process is repeated.

When it is determined in step S1214 that there is no intersection, the traverse line determination unit 42 ends processing.

As a result, the traverse line GD in the entire scanning including the traverse lines GD1, GDi, and GDj is determined.

In step S13, the display control unit 47 controls the display device 3 that displays the guide line OB1, which is an image indicating the traverse line GD, on the basis of the traverse line GD.

As described above, according to the first embodiment, the scanning system 100 receives the input of the pipeline information and the setting information, determines the traverse line GD on the basis of the pipeline information and the setting information, and controls the display device 3 that displays the guide line OB1, which is an image indicating the traverse line GD, on the basis of the traverse line GD. Therefore, the scanning system 100 can quickly scan the pipeline by causing the operator to quickly recognize the traverse line GD. The scanning system 100 can reduce the load required for the operator to determine the traverse line GD.

According to the first embodiment, in the scanning system 100, the display control unit 47 generates the superimposed image in which the guide line OB1, which is the image indicating the traverse line GD, is superimposed on the captured image in which the ground surface corresponding to the ground in which the pipeline is buried is captured by the imaging unit 43 on the basis of the position, direction, and posture of the imaging unit 43. The display control unit 47 controls the display device 3 to display the superimposed image. Therefore, the operator can accurately recognize the relationship between the traverse line GD of the scanning device 2 moved by the operator and the ground surface on which the image is shown in the captured image.

### Second Embodiment

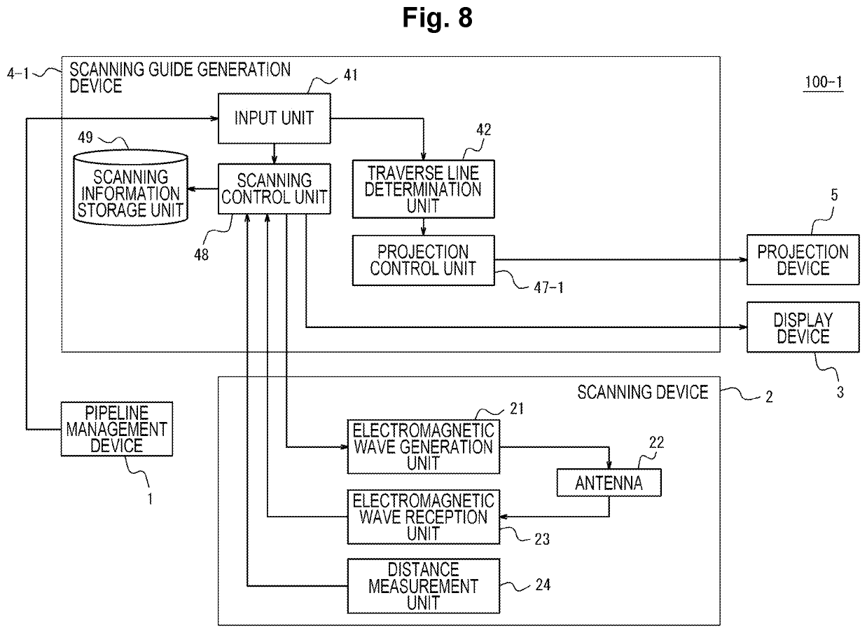

An overall configuration of a second embodiment will be described with reference to FIG. 8. FIG. 8 is a schematic view of a scanning system 100-1 according to a second embodiment. In the second embodiment, the same functional units as those in the first embodiment are denoted by the same reference numerals, and the description thereof will be omitted.

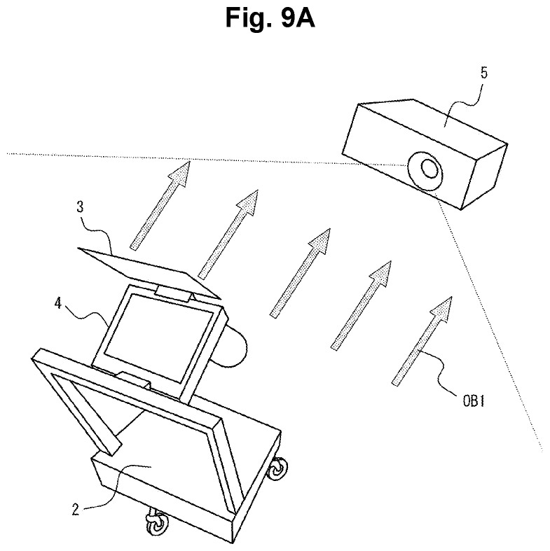

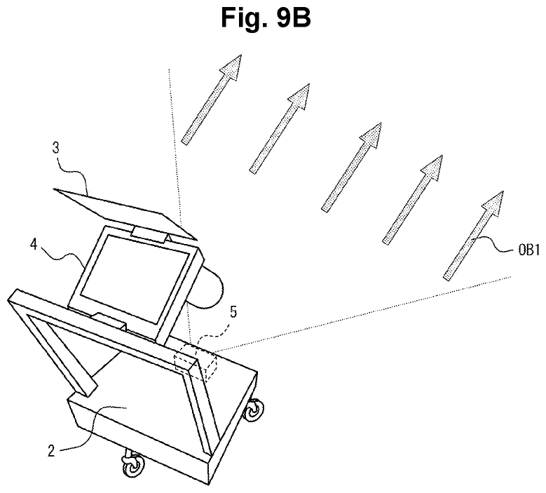

As illustrated in FIG. 8, a scanning system 100-1 includes a pipeline management device 1, a scanning device 2, a display device 3, a scanning guide generation device 4-1, and a projection device 5. The projection device 5 may be provided separately from the scanning guide generation device 4-1 as illustrated in FIG. 9A, or may be provided integrally with the scanning guide generation device 4-1 as illustrated in FIG. 9B.

### <Configuration of Scanning Guide Generation Device>

As illustrated in FIG. 8, the scanning guide generation device 4-1 includes an input unit 41, a traverse line determination unit 42, a projection control unit (device control unit) 47-1, a scanning control unit 48, and a scanning information storage unit 49.

The projection control unit 47-1 controls the projection device that projects a guide line OB1, which is an image indicating the traverse line GD.

Specifically, the projection control unit 47-1 generates a projection image including the guide line OB1, which is an image indicating the traverse line GD, on the basis of the position, direction, and posture of the image display surface of the projection device 5. For example, the projection control unit 47-1 calculates the correspondence relationship between the position in the projection image and the real space on which the projection image is projected on the basis of the position, direction, and posture of the image display surface of the projection device 5. Information indicating the position, direction, and posture of the image display surface of the projection device 5 may be transmitted to the scanning guide generation device 4-1 via a communication network, or input may be received by the input unit 41.

As in the example illustrated in FIG. 9B, in the configuration in which the projection device 5 is provided integrally with the scanning guide generation device 4-1, the scanning guide generation device 4-1 may further include a position detection unit 44, a direction detection unit 45, and a posture detection unit 46. In this case, the position, direction, and posture of the image display surface of the projection device 5 may be detected by the position detection unit 44, the direction detection unit 45, and the posture detection unit 46, respectively.

Then, the projection control unit 47-1 controls the projection device 5 to project the guide line OB1, which is an image indicating the traverse line GD, at the position of the traverse line GD in the real space on the basis of the correspondence relationship between the position in the projection image and the real space where the projection image is projected. In the example illustrated in FIGS. 9A and 9B, the guide line OB1 has a shape of an arrow indicating the position and direction of the traverse line GD.

At this time, the projection control unit 47-1 may control the projection device 5 to project a projection image further including an image object OB2 indicating a pipeline to be scanned. Specifically, the projection control unit 47-1 may control the projection device 5 so that the image object OB2 is projected at the position of the pipeline to be scanned in the real space.

The projection control unit 47-1 may control the projection device 5 to project a projection image further including an image object OB3 indicating a pipeline different from the pipeline to be scanned. Specifically, the projection control unit 47-1 may control the projection device 5 so that the image object OB2 is projected at the position of the pipeline different from the pipeline to be scanned in the real space.

As illustrated in FIGS. 9A and 9B, the projection control unit 47-1 controls the projection device 5 to project a projection image on the ground surface.

### <Configuration of Projection Device>

The projection device 5 projects an image under the control of the scanning guide generation device 4-1. The projection device 5 includes a projector including a liquid crystal panel, digital light processing (DLP), and the like.

### <Operation of Scanning System>

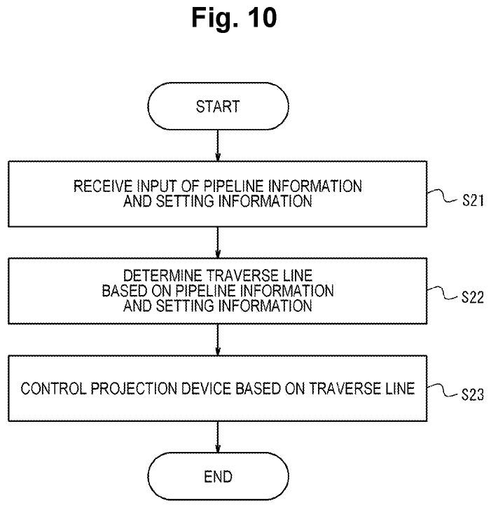

Here, an operation of the scanning system 100-1 according to the second embodiment is a flowchart illustrating an example of an operation of FIG. 10. The operation in the scanning system 100-1 described below with reference to FIG. 10 corresponds to an example of the scanning method of the scanning system 100-1 according to the second embodiment.

In step S21, the input unit 41 receives an input of pipeline information indicating position and shape of a pipeline in the ground below the ground surface on which the scanning device 2 moves, and setting information indicating a condition of a traverse line GD indicating path and direction for moving the scanning device 2 on the ground surface.

In step S22, the traverse line determination unit 42 determines the traverse line GD on the basis of the pipeline information and the setting information. Details of step S22 are similar to the details of step S12 in the first embodiment.

In step S23, the projection control unit 47-1 controls the projection device 5 that projects the guide line OB1, which is an image indicating the traverse line GD, on the basis of the traverse line GD.

As described above, according to the second embodiment, the scanning system 100-1 receives the input of the pipeline information and the setting information, determines the traverse line GD on the basis of the pipeline information and the setting information, and controls the projection device 5 that projects the guide line OB1, which is an image indicating the traverse line GD, on the basis of the traverse line GD. Therefore, the scanning system 100-1 can quickly scan the pipeline by causing the operator to quickly recognize the traverse line GD. The scanning system 100-1 can reduce the load required for the operator to determine the traverse line GD. Another person (for example, the owner of the pipeline and a person involved in the inspection work) at a position where the operator cannot see the display device 3 disposed so as to see the traverse line GD can also quickly recognize the traverse line GD.

Specifically, according to the second embodiment, in the scanning system 100-1, the projection control unit 47-1 generates a projection image including the guide line OB1, which is an image indicating the traverse line GD, on the basis of the position, direction, and posture of the image display surface of the projection device 5. Then, the projection control unit 47-1 controls the projection device 5 to project a projection image on the ground surface. Therefore, the operator can accurately recognize the position of the traverse line GD of the scanning device 2 moved by the operator. In addition, another person at a position where the person cannot view the display device 3 can also accurately recognize the position of the traverse line GD.

### Third Embodiment

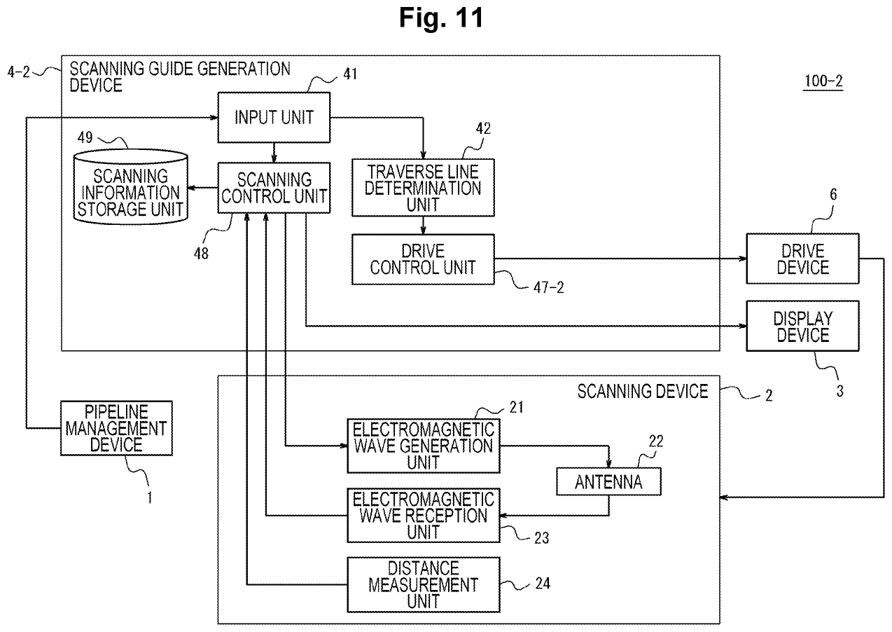

An overall configuration of a third embodiment will be described with reference to FIG. 11. FIG. 11 is a schematic diagram of a scanning system 100-2 according to a third embodiment. The same functional units as those in the second embodiment are denoted by the same reference numerals, and the description thereof will be omitted.

As illustrated in FIG. 11, the scanning system 100-2 according to the third embodiment includes a pipeline management device 1, a scanning device 2, a display device 3, a scanning guide generation device 4-2, and a drive device 6.

### <Configuration of Scanning Guide Generation Device>

The scanning guide generation device 4-2 includes an input unit 41, a traverse line determination unit 42, an imaging unit 43, a position detection unit 44, and a drive control unit (device control unit) 47-2, a scanning control unit 48, and a scanning information storage unit 49.

The drive control unit 47-2 controls the drive device 6 that drives the scanning device 2 so as to move along the path and direction indicated by the traverse line GD determined by the traverse line determination unit 42.

For example, the drive control unit 47-2 may control the scanning device 2 such that the drive device 6 moves in the path and direction indicated by the traverse line GD on the basis of the current position of the scanning device 2. The current position of the scanning device 2 may be acquired by any method. For example, the scanning device 2 may include a position detection unit such as a GPS receiver, and information indicating the position detected by the position detection unit may be transmitted to the scanning guide generation device 4-2. Furthermore, the scanning device 2 may be configured integrally with the scanning guide generation device 4-2, the scanning guide generation device 4-2 may include a position detection unit such as a GPS receiver, and the current position of the scanning device 2 may be detected by the position detection unit.

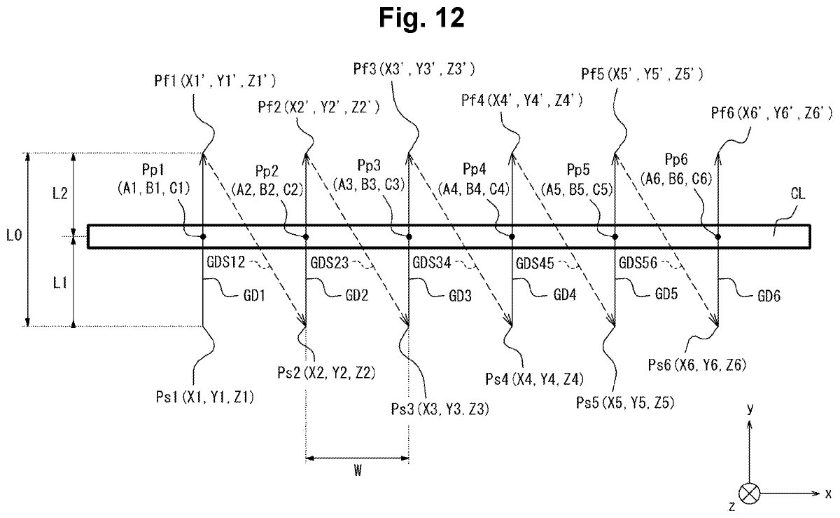

The drive control unit 47-2 may determine an auxiliary line GDS that passes through the unit scanning end position Pf of the traverse line GD in one unit scanning to the unit scanning start position Ps of the traverse line GD in another unit scanning in the shortest time as illustrated in FIG. 12. At this time, the traverse line GD in another unit scanning may be the traverse line GD located closest to the traverse line GD in one unit scanning. In such a configuration, the drive control unit 47-2 may control the scanning device 2 to move in the path and direction indicated by the auxiliary line GDS from the unit scanning end position of one traverse line GD to the unit scanning start position Ps of the traverse line GD in another unit scanning.

The scanning control unit 48 of the third embodiment may perform control the scanning device 2 to generate an electromagnetic wave when the scanning device 2 moves in the path and direction indicated by the traverse line GD. The scanning control unit 48 may perform control the scanning device 2 not to generate an electromagnetic wave when the scanning device 2 moves in the path and direction indicated by the auxiliary line GDS.

### <Configuration of Drive Device>

The drive device 6 drives the scanning device 2 under the control of the scanning guide generation device 4-2. The drive device 6 includes a motor or the like.

### <Operation of Scanning System>

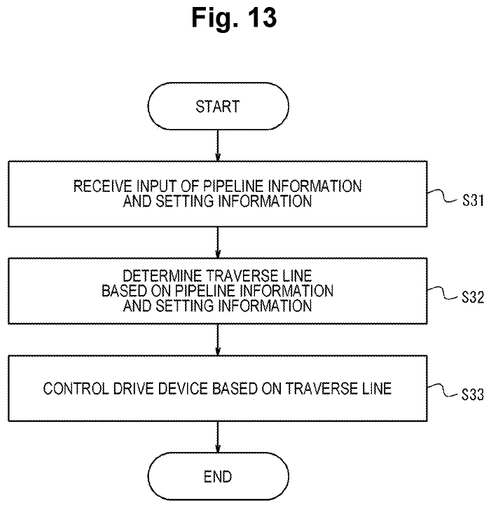

Here, operation of the scanning system 100-2 according to the third embodiment will be described with reference to FIG. 13. FIG. 13 is a sequence diagram illustrating an example of the operation of the scanning system 100-2 according to the third embodiment. The operation in the scanning system 100-2 described below with reference to FIG. 13 corresponds to an example of the scanning method of the scanning system 100-2 according to the third embodiment.

In step S31, the input unit 41 receives an input of pipeline information indicating position and shape of a pipeline in the ground below the ground surface on which the scanning device 2 moves, and setting information indicating a condition of a traverse line GD indicating path and direction for moving the scanning device 2 on the ground surface.

In step S32, the traverse line determination unit 42 determines the traverse line GD on the basis of the pipeline information and the setting information. Details of step S32 are similar to the details of step S12 in the first embodiment.

In step S33, the drive control unit 47-2 controls the drive device 6 that drives the scanning device 2 so as to move along the path and direction indicated by the traverse line GD determined by the traverse line determination unit 42.

As described above, according to the third embodiment, the scanning system 100-2 receives the input of the pipeline information and the setting information, determines the traverse line GD on the basis of the pipeline information and the setting information, and controls the drive device 6 that drives the scanning device 2, on the basis of the traverse line GD. Therefore, the scanning system 100-2 can quickly scan the pipeline without the operator recognizing the traverse line GD. The scanning system 100-2 can reduce the load required for the operator to determine the traverse line GD.

When the traverse line GD is determined as described in the first to third embodiments, the directions of the respective traverse lines GD of the plurality of pieces of unit scanning are the same. As a result, for example, the distribution of the electromagnetic wave intensity in each of the two unit scanning in which the traverse line GD is adjacent to each other is expressed by being shifted by the scanning interval W. Therefore, the operator can easily recognize the distribution in the plurality of pieces of unit scanning in association with the position in the real space. On the other hand, when the directions of the traverse lines GD in the plurality of pieces of unit scanning are not the same, the distributions in the two pieces of unit scanning may be represented by being shifted by the scanning interval W and further inverted. Therefore, the operator cannot easily recognize the distribution in the plurality of unit scanning in association with the position in the real space. As described above, the operator can easily specify the position of the pipeline since the directions the traverse lines GD of the plurality of pieces of unit scanning are the same.

### First Modification

In the first to third embodiments described above, the traverse line determination unit 42 may determine the traverse line GD so that the directions of the traverse lines GD of the plurality of pieces of unit scanning are different. In such a configuration, the length of the auxiliary line GDS may be shorter than that in a case where the orientations of all the traverse lines GD are the same. In this case, the scanning device 2 can efficiently move from the unit scanning end position Pf of one traverse line GD to the unit scanning start position Ps of another traverse line GD that moves next to the one traverse line GD.

### Second Modification

In the first example and the second example of the first embodiment described above, the scanning length included in the setting information is the second scanning length L2, but the scanning length is not limited thereto. For example, the scanning length included in the setting information may be an entire scanning length L0. In such a configuration, when determining the i-th pipeline scanning position Ppi, the traverse line determination unit 42 determines the i-th unit scanning end position Pfi such that the distance from the i-th unit scanning start position Psi to the i-th unit scanning end position Pfi becomes the entire scanning length L0. As similar to this, when determining the j-th pipeline scanning position Ppj, the traverse line determination unit 42 determines the j-th unit scanning end position Pfj such that the distance from the j-th unit scanning start position Psj to the j-th unit scanning end position Pfj becomes the entire scanning length L0.

### Third Modification

In the first to third embodiments, the traverse line determination unit 42 determines the pipeline scanning position Pp on the basis of the unit scanning start position Ps and the position and shape of the pipeline, and determines the unit scanning end position Pf on the basis of the pipeline scanning position Pp and the scanning length, but the determination is not limited thereto. For example, the traverse line determination unit 42 may determine the pipeline scanning position Pp on the basis of the unit scanning end position Pf and the position and shape of the pipeline. Then, the traverse line determination unit 42 may determine the unit scanning start position Ps on the basis of the pipeline scanning position Pp and the scanning length.

### Fourth Modification

In the first to third embodiments, when the pipeline has an arc shape, the traverse line determination unit 42 determines the unit scanning start position Ps as the center O of the circle, but the determination is not limited thereto. For example, the traverse line determination unit 42 may determine the unit scanning end position Pf as the center O of the circle. In such a configuration, the traverse line determination unit 42 may determine the pipeline scanning position Pp on the basis of the unit scanning end position Pf and the position and shape of the pipeline. Then, the traverse line determination unit 42 may determine the unit scanning start position Ps on the basis of the pipeline scanning position Pp and the scanning length.

### Fifth Modification

Unlike the display device 3 of the first embodiment, the display device 3 of the second and third embodiments may not display the superimposed image.

### <Program>

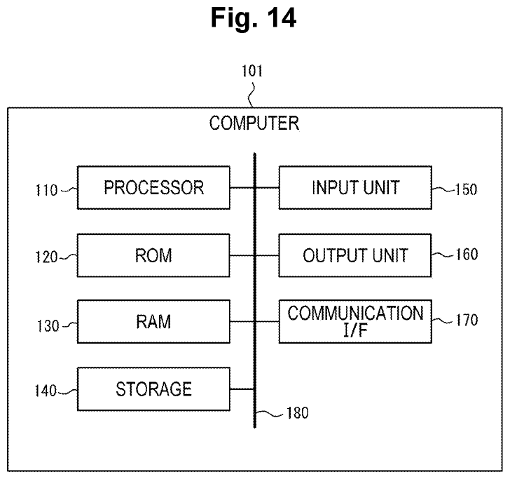

The scanning guide generation devices 4, 4-1, and 4-2 described above can be implemented by a computer 101. Furthermore, a program for causing the scanning guide generation devices 4, 4-1, and 4-2 to function may be provided. Also, the program may be stored in a storage medium or may be provided through a network. FIG. 14 is a block diagram illustrating a schematic configuration of the computer 101 that functions as each of the scanning guide generation devices 4, 4-1, and 4-2. Here, the computer 101 may be a general-purpose computer, a dedicated computer, a workstation, a personal computer (PC), an electronic notebook pad, or the like. The program instruction may be a program code, a code segment, or the like for executing required tasks.

As illustrated in FIG. 14, the computer 101 includes a processor 110, a read only memory (ROM) 120, a random access memory (RAM) 130, a storage 140, an input unit 150, a display unit 160, and a communication interface (I/F) 170. The components are communicably connected to each other via a bus 180. Specifically, the processor 110 is a central processing unit (CPU), a micro processing unit (MPU), a graphics processing unit (GPU), a digital signal processor (DSP), a system on a chip (SoC), or the like and may be configured by the same or different types of plurality of processors.

The processor 110 executes control of the components and various types of arithmetic processing. That is, the processor 110 reads a program from the ROM 120 or the storage 140 and executes the program by using the RAM 130 as a working region. The processor 110 controls the components described above and performs various types of arithmetic processing according to a program stored in the ROM 120 or the storage 140. In the embodiment described above, the program according to the present disclosure is stored in the ROM 120 or the storage 140.

The program may be stored in a storage medium readable by the computer 101. When such a storage medium is used, the program can be installed in the computer 101. Here, the storage medium on which the program is stored may be a non-transitory storage medium. The non-transitory storage medium is not particularly limited, but may be, for example, a CD-ROM, a DVD-ROM, a universal serial bus (USB) memory, or the like. The program may be downloaded from an external device via a network.

The ROM 120 stores various programs and various types of data. The RAM 130 temporarily stores a program or data as a working area. The storage 140 includes a hard disk drive (HDD) or a solid state drive (SSD) and stores various programs including an operating system and various types of data.

The input unit 150 includes one or more input interfaces that receive a user's input operation and acquire information based on the user's operation. Examples of the input unit 150 include, but are not limited to, a pointing device, a keyboard, and a mouse.

The display unit 160 includes one or more output interfaces that output information. Example of the display unit 160 include, but are not limited to, a display that outputs information as a video and a speaker that outputs information as a sound. The display unit 160 also functions as the input unit 150 when the display unit 160 is a touch panel type display.

The communication interface (I/F) 170 is an interface for communicating with an external device.

Regarding the above embodiment, the following supplementary notes are further disclosed.

### (Supplement 1)

A scanning system including a scanning device that moves on a ground surface and scans ground below the ground surface, and a scanning guide generation device,
in which the scanning guide generation device includes:
an input interface that receives an input of pipeline information indicating assumed position and shape of a pipeline in the ground and setting information indicating a condition of a traverse line indicating path and direction in which the scanning device moves on the ground surface; and
a control unit, and
the control unit
determines the traverse line based on the pipeline information and the setting information, and
controls a display device that displays a guide line that is an image indicating the traverse line, a projection device that projects the guide line, or a drive device that drives the scanning device.

### (Supplement 2)

The scanning system according to supplement 1,
in which the scanning guide generation device further includes a camera that generates a captured image obtained by imaging the ground surface, and
the control unit generates a superimposed image in which the guide line is superimposed on the captured image based on a position, a direction, and a posture of an imaging surface of the imaging unit, and controls the display device to display the superimposed image.

### (Supplement 3)

The scanning system according to supplement 1, in which the control unit generates a projection image including the guide line based on a position, a direction, and a posture of an image display surface of the projection device, and controls the projection device to project the projection image on the ground surface.

### (Supplement 4)

The scanning system according to supplement 1, in which the control unit controls a drive device that drives the scanning device so as to move the traverse line.

### (Supplement 5)

The scanning system according to any one of supplements 1 to 3, in which the setting information includes: a scanning length that indicates a length by which the scanning device moves on one straight line; a scanning interval that indicates an interval in an extending direction of unit scanning by which the scanning device scans while moving on the one straight line extending in a direction orthogonal to the extending direction of a pipeline corresponding region that is a region obtained by projecting a region of the pipeline in the ground onto the ground surface; and an entire scanning start position that is a position at which entire scanning including a plurality of pieces of the unit scanning is started, and
the control unit determines a unit scanning start position at which the unit scanning is started based on the entire scanning start position, determines a unit scanning end position that is a position to end the unit scanning based on the unit scanning start position, an extending direction of the pipeline indicated by the shape, and the scanning length, determines a length and a direction from the unit scanning start position to the unit scanning end position as the traverse line in the unit scanning, and determines the traverse line in the unit scanning a plurality of times based on the scanning interval to determine a traverse line of the entire scanning including the plurality of pieces of the unit scanning.

### (Supplement 6)

A scanning guide generation device including:
an input interface that receives an input of pipeline information indicating position and shape of a pipeline in the ground below the ground surface on which a scanning device moves and setting information indicating a condition of a traverse line indicating path and direction in which the scanning device moves on the ground surface; and
a control unit,
in which the control unit
determines the traverse line based on the pipeline information and the setting information, and controls a display device that displays a guide line that is an image indicating the traverse line, a projection device that projects the guide line, or a drive device that drives the scanning device.

### (Supplement 7)

A scanning method including steps: of
receiving an input of pipeline information indicating assumed position and shape of a pipeline in ground below a ground surface on which a scanning device moves and setting information indicating a condition of a traverse line indicating path and direction in which the scanning device moves on the ground surface;
determining the traverse line based on the pipeline information and the setting information; and
controlling a display device that displays a guide line that is an image indicating the traverse line, a projection device that projects the guide line, or a drive device that drives the scanning device.

### (Supplement 8)

A non-transitory storage medium that stores a program that can be executed by a computer, the non-transitory storage medium causing the computer to function as the scanning guide generation device according to supplement 6.

All documents, patent applications, and technical standards described in this specification are incorporated herein by reference to the same extent as if each individual document, patent application, and technical standard were specifically and individually described to be incorporated by reference.

Although the above-described embodiments have been described as representative examples, it is apparent to those skilled in the art that many modifications and substitutions can be made within the spirit and scope of the present disclosure. Accordingly, it should not be understood that the present invention is limited by the above-described embodiments, and various modifications or changes can be made within the scope of the claims. For example, a plurality of configuration blocks illustrated in the configuration diagrams of the embodiments can be combined into one, or one configuration block can be divided.

### REFERENCE SIGNS LIST

1 Pipeline management device
2 Scanning device
3 Display device
4, 4-1, 4-2 Scanning guide generation device
5 Projection device
6 Drive device
21 Electromagnetic wave generation unit
22 Antenna
23 Electromagnetic wave reception unit
24 Distance measurement unit
41 Input unit
42 Traverse line determination unit
43 Imaging unit
44 Position detection unit
45 Direction detection unit
46 Posture detection unit
47 Display control unit
47-1 Projection control unit
47-2 Drive control unit
48 Scanning control unit
49 Scanning information storage unit
100, 100-1, 100-2Scanning system
101 Computer
110 Processor
120 ROM
130 RAM
140 Storage
150 Input unit
160 Output unit
170 Communication interface
180 Bus

1. A scanning system comprising:
a scanning device that moves on a ground surface and scans ground below the ground surface, and
a scanning guide generation device comprising a processor configured to execute operations comprising:
receiving an input of:
pipeline information indicating assumed position and shape of a pipeline in the ground, and
setting information indicating a condition of a traverse line indicating path and direction in which the scanning device moves on the ground surface;
determining the traverse line based on the pipeline information and the setting information; and
transmitting an instruction to at least one of:
a display device that displays a guide line that is an image indicating the traverse line,
a projection device that projects the guide line, or
a drive device that drives the scanning device.

2. The scanning system according to claim 1, wherein the processor of the scanning guide generation device further configured to execute operations comprising:
generating a captured image obtained by imaging the ground surface, and
generating a superimposed image in which the guide line is superimposed on the captured image based on a position, a direction, and a posture of an imaging surface, and
transmitting an instruction to controls the display device to display the superimposed image.

3. The scanning system according to claim 1, wherein the transmitting an instruction further comprises:
generating a projection image including the guide line based on a position, a direction, and a posture of an image display surface of the projection device, and
transmitting an instruction to the projection device to project the projection image on the ground surface.

4. The scanning system according to claim 1, wherein the transmitting an instruction further comprises transmitting an instruction to a drive device that drives the scanning device so as to move the traverse line.

5. The scanning system according to claim 1, wherein the setting information includes:
a scanning length that indicates a length by which the scanning device moves on one straight line,
a scanning interval that indicates an interval in an extending direction of unit scanning by which the scanning device scans while moving on the one straight line extending in a direction orthogonal to the extending direction of a pipeline corresponding region that is a region obtained by projecting a region of the pipeline in the ground onto the ground surface, and
an entire scanning start position that is a position at which entire scanning including a plurality of pieces of the unit scanning is started, and
the determining the traverse line further comprises:
determining a unit scanning start position at which the unit scanning is started based on the entire scanning start position,
determining a unit scanning end position that is a position to end the unit scanning based on the unit scanning start position, an extending direction of the pipeline indicated by the shape, and the scanning length,
determining the traverse line in the unit scanning based on the unit scanning start position and the unit scanning end position, and
determining the traverse line in the unit scanning a plurality of times based on the scanning interval to determine a traverse line of the entire scanning including the plurality of pieces of the unit scanning.

6. A scanning guide generation device comprising a processor configured to execute operations comprising:
receiving an input of pipeline information indicating position and shape of a pipeline in ground below a ground surface on which a scanning device moves and setting information indicating a condition of a traverse line indicating path and direction in which the scanning device moves;
determining the traverse line based on the pipeline information and the setting information; and
transmitting an instruction to at least one of:
a display device that displays a guide line that is an image indicating the traverse line,
a projection device that projects the guide line, or
a drive device that drives the scanning device.

7. A scanning method comprising: receiving an input of:
pipeline information indicating assumed position and shape of a pipeline in ground below a ground surface on which a scanning device moves, and
setting information indicating a condition of a traverse line indicating path and direction in which the scanning device moves on the ground surface;
determining the traverse line based on the pipeline information and the setting information; and
transmitting an instruction to at least one of:
a display device that displays a guide line that is an image indicating the traverse line,
a projection device that projects the guide line, or
a drive device that drives the scanning device.

8. (canceled)

9. The scanning system according to claim 2, wherein the setting information includes:
a scanning length that indicates a length by which the scanning device moves on one straight line,
a scanning interval that indicates an interval in an extending direction of unit scanning by which the scanning device scans while moving on the one straight line extending in a direction orthogonal to the extending direction of a pipeline corresponding region that is a region obtained by projecting a region of the pipeline in the ground onto the ground surface, and
an entire scanning start position that is a position at which entire scanning including a plurality of pieces of the unit scanning is started, and
the determining the traverse line further comprises:
determining a unit scanning start position at which the unit scanning is started based on the entire scanning start position,
determining a unit scanning end position that is a position to end the unit scanning based on the unit scanning start position, an extending direction of the pipeline indicated by the shape, and the scanning length,
determining the traverse line in the unit scanning based on the unit scanning start position and the unit scanning end position, and
determining the traverse line in the unit scanning a plurality of times based on the scanning interval to determine a traverse line of the entire scanning including the plurality of pieces of the unit scanning.

10. The scanning guide generation device according to claim 6, wherein the processor of the scanning guide generation device further configured to execute operations comprising:
generating a captured image obtained by imaging the ground surface, and
generating a superimposed image in which the guide line is superimposed on the captured image based on a position, a direction, and a posture of an imaging surface, and
transmitting an instruction to controls the display device to display the superimposed image.

11. The scanning guide generation device according to claim 6, wherein the transmitting an instruction further comprises:
generating a projection image including the guide line based on a position, a direction, and a posture of an image display surface of the projection device, and
transmitting an instruction to the projection device to project the projection image on the ground surface.

12. The scanning guide generation device according to claim 6, wherein the transmitting an instruction further comprises transmitting an instruction to a drive device that drives the scanning device so as to move the traverse line.

13. The scanning guide generation device according to claim 6, wherein the setting information includes:
a scanning length that indicates a length by which the scanning device moves on one straight line,
a scanning interval that indicates an interval in an extending direction of unit scanning by which the scanning device scans while moving on the one straight line extending in a direction orthogonal to the extending direction of a pipeline corresponding region that is a region obtained by projecting a region of the pipeline in the ground onto the ground surface, and
an entire scanning start position that is a position at which entire scanning including a plurality of pieces of the unit scanning is started, and
the determining the traverse line further comprises:
determining a unit scanning start position at which the unit scanning is started based on the entire scanning start position,
determining a unit scanning end position that is a position to end the unit scanning based on the unit scanning start position, an extending direction of the pipeline indicated by the shape, and the scanning length,
determining the traverse line in the unit scanning based on the unit scanning start position and the unit scanning end position, and
determining the traverse line in the unit scanning a plurality of times based on the scanning interval to determine a traverse line of the entire scanning including the plurality of pieces of the unit scanning.

14. The scanning guide generation device according to claim 10, wherein the setting information includes:
a scanning length that indicates a length by which the scanning device moves on one straight line,
a scanning interval that indicates an interval in an extending direction of unit scanning by which the scanning device scans while moving on the one straight line extending in a direction orthogonal to the extending direction of a pipeline corresponding region that is a region obtained by projecting a region of the pipeline in the ground onto the ground surface, and
an entire scanning start position that is a position at which entire scanning including a plurality of pieces of the unit scanning is started, and
the determining the traverse line further comprises:
determining a unit scanning start position at which the unit scanning is started based on the entire scanning start position,
determining a unit scanning end position that is a position to end the unit scanning based on the unit scanning start position, an extending direction of the pipeline indicated by the shape, and the scanning length,
determining the traverse line in the unit scanning based on the unit scanning start position and the unit scanning end position, and
determining the traverse line in the unit scanning a plurality of times based on the scanning interval to determine a traverse line of the entire scanning including the plurality of pieces of the unit scanning.

15. The scanning method according to claim 7, wherein the processor of the scanning guide generation device further configured to execute operations comprising:
generating a captured image obtained by imaging the ground surface, and
generating a superimposed image in which the guide line is superimposed on the captured image based on a position, a direction, and a posture of an imaging surface, and
transmitting an instruction to controls the display device to display the superimposed image.

16. The scanning method according to claim 7, wherein the transmitting an instruction further comprises:
generating a projection image including the guide line based on a position, a direction, and a posture of an image display surface of the projection device, and
transmitting an instruction to the projection device to project the projection image on the ground surface.

17. The scanning method according to claim 7, wherein the transmitting an instruction further comprises transmitting an instruction to a drive device that drives the scanning device so as to move the traverse line.

18. The scanning method according to claim 7, wherein the setting information comprises:
a scanning length that indicates a length by which the scanning device moves on one straight line,
a scanning interval that indicates an interval in an extending direction of unit scanning by which the scanning device scans while moving on the one straight line extending in a direction orthogonal to the extending direction of a pipeline corresponding region that is a region obtained by projecting a region of the pipeline in the ground onto the ground surface, and
an entire scanning start position that is a position at which entire scanning including a plurality of pieces of the unit scanning is started, and
the determining the traverse line further comprises:
determining a unit scanning start position at which the unit scanning is started based on the entire scanning start position,
determining a unit scanning end position that is a position to end the unit scanning based on the unit scanning start position, an extending direction of the pipeline indicated by the shape, and the scanning length,
determining the traverse line in the unit scanning based on the unit scanning start position and the unit scanning end position, and
determining the traverse line in the unit scanning a plurality of times based on the scanning interval to determine a traverse line of the entire scanning including the plurality of pieces of the unit scanning.
